(19) United States
(12) Patent Application Publication
(10) Pub. No.: US 2016/0284305 A1
(43) Pub. Date: Sep. 29, 2016

(54) DISPLAY DEVICE AND DISPLAY DRIVING METHOD

(71) Applicant: SHENZHEN CHINA STAR OPTOELECTRONICS TECHNOLOGY CO., LTD, Shenzhen, Guangdong (CN)

(72) Inventor: Xiangyang XU, Shenzhen, Guangdong (CN)

(21) Appl. No.: 14/413,153

(22) PCT Filed: Dec. 27, 2013
(86) PCT No.: PCT/CN2013/090783

§ 371 Date: Jan. 6, 2015

(30) Foreign Application Priority Data
Dec. 20, 2013 (CN) 201310714940.2

(51) Int. Cl. G09G 3/36

(52) U.S. Cl. CPC G09G 3/3677; G09G 3/3648; G09G 2310/0205

(57) ABSTRACT

A display driving method, applied in a display device, the method includes: controlling a gate driver to turn on pixel units of each row in sequence via scanning lines, and to scan pixel units of a next row before a scanning time of the pixel units of each row has been finished for a predetermined time (S301). And controlling a first signal driver to apply display driving signals to the pixel units of odd rows synchronously, when the pixel units of the odd rows are being scanned to turn on; and controlling the second signal driver to apply the display driving signals to the pixel units of even rows, when the pixel units of the even rows are being scanned to turn on (S302).

### FIELD OF THE INVENTION

The present invention relates to driving methods, and more particularly, to a display driving method and a display device.

### BACKGROUND OF THE INVENTION

Nowadays, display devices, such as liquid crystal display (LCD) devices are usually adopts Z-shaped driving method and dual data driving method to drive. The dual data driving method is usual used to drive a display screen with a large size, the main advantage of the dual data driving method is it can decrease charge frequency of signals, thus decreasing power consume. However, because the resolution ratio and the refresh ratio are enhanced more and more, the LCD device adopting the dual data driving method should increases charging ratio to satisfy the requirement of charge amounts of the LCD devices. However, it would brings problems of cost and technique if increase the charging ratio, specially for the display screen with the large size driven by the dual data driving method.

### SUMMARY OF THE INVENTION

The present invention provides a display device and a display driving method, which can increase charging time and do not need to increase the charging ratio, and decrease the cost.

A display device, comprising an array substrate, a time schedule controller, a gate driver, a first signal driver, and a second signal driver, the array substrate comprises a plurality of pixel units arrayed in matrix array, a plurality of scanning lines, a plurality of odd signal lines, and a plurality of even signal lines; each scanning line is connected to pixel units of one corresponding row, each odd signal line is connected to odd row pixel units of one corresponding column, each even signal line is connected to even row pixel units of one corresponding column; the gate driver is connected to all of the scanning lines, the first signal driver is connected to all of the odd signal lines, the second signal driver is connected to all of the even signal lines; wherein, the time schedule controller controls the gate driver to turn on each row of pixel units in sequence via the scanning lines, and to scan a next row of pixel units before a scanning time of each row of pixel units has been finished for a predetermined time; the time schedule controller controls the first signal driver to apply the display driving signals to the pixel units of odd rows synchronously, when the pixel units of the odd rows are being scanned to turn on; the time schedule controller further controls the second signal driver to apply the display driving signals to the pixel units of even rows, when the pixel units of the even rows are being scanned to turn on.

Wherein, the predetermined time is one half of the scanning time, the gate driver scans a next row of pixel units after each row of pixel units has been scanned for one half of the scanning time.

Wherein, the predetermined time is a quarter of the scanning time, the gate driver scans a next row of pixel units after each row of pixel units has been scanned for three quarters of the scanning time.

Wherein, the display device is a liquid crystal display (LCD) television, a LCD display, a mobile phone, a tablet computer, or a portable computer.

An display driving method, applied in a display device, comprising: a) controlling a gate driver to turn on pixel units of each row in sequence via scanning lines, and to scan pixel units of a next row before a scanning time of the pixel units of each row has been finished for a predetermined time; and b) controlling a first signal driver to apply display driving signals to the pixel units of odd rows synchronously, when the pixel units of the odd rows are being scanned to turn on; and controlling the second signal driver to apply the display driving signals to the pixel units of even rows, when the pixel units of the even rows are being scanned to turn on.

Wherein, the method further comprising: judging whether the pixel units of all of rows are driven completely, if not, returning to the step a).

Wherein, the step a) comprises: controlling the gate driver to turn on the each row of pixel units in sequence via scanning lines, and controlling the gate driver to scan a next row of pixel units after each row of pixel units has been scanned for one half of a scanning time.

Wherein, the step a) comprises: controlling the gate driver to turn on the each row of pixel units in sequence via scanning lines, and controlling the gate driver to scan a next row of pixel units after each row of pixel units has been scanned for three quarters of a scanning time.

The display device and the display driving method of the present invention, can increase charging time and do not need to increase the charging ratio.

### BRIEF DESCRIPTION OF THE DRAWINGS

FIG. 1 illustrates a structure diagram of a display device of an embodiment;

FIG. 2 illustrates a schematic diagram of a driving time sequence of an embodiment; and

FIG. 3 illustrates a flowchart of a display driving method of an embodiment.

### DETAILED DESCRIPTION OF THE PREFERRED EMBODIMENTS

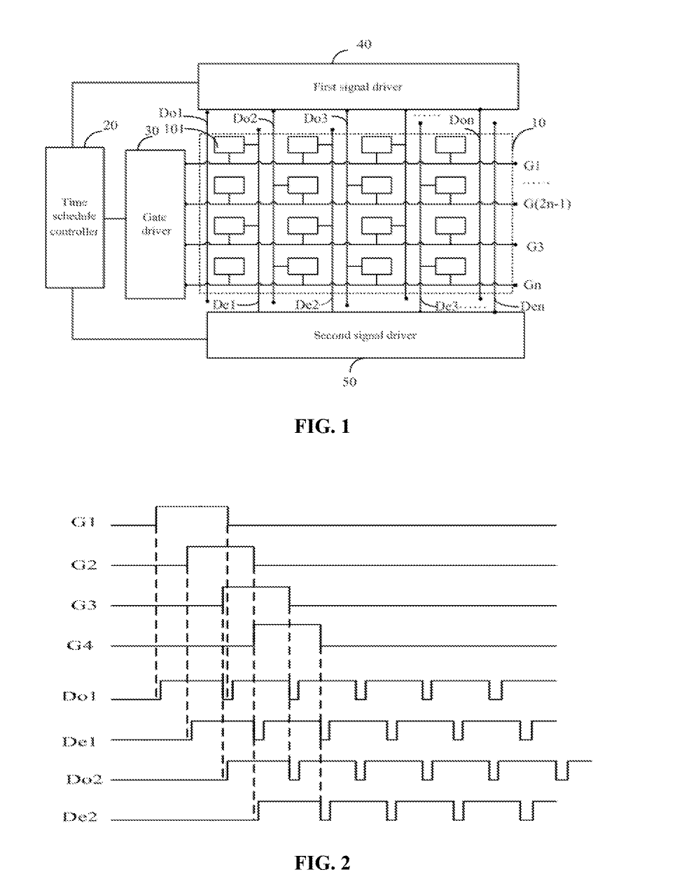

Referring to FIG. 1, a structure diagram of a display device 100 is illustrated. The display device 100 includes an array substrate 10, a time schedule controller 20, a gate driver 30, a first signal driver 40, and a second signal driver 50.

The array substrate 10 includes a number of pixel units 101 arrayed in matrix array, a number of scanning lines G1-Gn, a number of odd signal lines Do1-Don, and a number of even signal lines De1-Den.

Each scanning line is connected to pixel units 101 of one corresponding row, namely one pixel unit row. Each odd signal line is connected to odd row pixel units 101 of one corresponding column. Each even signal line is connected to even row pixel units 101 of one corresponding column.

The gate driver 30 is connected to all of the scanning lines G1-Gn. The first signal driver 40 is connected to all of the odd signal lines Do1-Don, and is used to apply display driving signals to drive the pixel units 101 of odd rows to display. The second signal driver 50 is connected to all of the even signal lines De1-Den, and is used to apply display driving signals to drive the pixel units 101 of even rows to display.

The time schedule controller 20 is connected to the gate driver 30, the first signal driver 40, and the second signal driver 50, and is used to provide a synchronizing start signal to the gate driver 30, the first signal driver 40, and the second signal driver 50, thus to drive a frame of image to display.

In detail, the time schedule controller 20 controls the gate driver 30 to turn on each row of pixel units 101 in sequence via the scanning lines G1-Gn, and to scan a next row of pixel units 101 before a scanning time of each row of pixel units 101 has been finished for a predetermined time. Therein, the scanning time of each row of pixel units 101 is a duration of scanning one row of pixel units 101, and is equal to a general scanning time of scanning each row of pixel units 101.

The time schedule controller 20 then controls the first signal driver 40 to apply the display driving signals to the pixel units 101 of odd rows synchronously, when the pixel units 101 of the odd rows are being scanned to turn on. The time schedule controller 20 then controls the second signal driver 50 to apply the display driving signals to the pixel units 101 of even rows, when the pixel units 101 of the even rows are being scanned to turn on.

Referring to FIG. 2 together, in the embodiment, the predetermined time is one half of the scanning time, the time schedule controller 20 controls the gate driver 30 to scan a next row of pixel units 101 after each row of pixel units 101 has been scanned for one half of the scanning time. For example, after scanning a first row of pixel units 101 for the one half of the scanning time via a first row of scanning line G1, scanning a second row of pixel units 101 via a second row of scanning line G2; and then after scanning the second row of pixel units 101 for the one half of the scanning time, scanning a third row of pixel units 101 via a third row of scanning line G3; and after scanning the third row of pixel units 101 for one half of the scanning time, scanning a fourth row of pixel units 101 via a fourth row of scanning line G4. Therefore, each row of pixel units 101 has one half of scanning time overlapped by a previous row of pixel units 101 and a next row of pixel units 101.

As shown in FIG. 2, because of the first signal driver 40 and the second signal driver 50 respectively apply the display driving signals when the pixel units 101 of odd rows and the pixel units 101 of even rows are turned on, the time of the display driving signals applied by the first signal driver 40 and the second signal driver 50 are maintained twice. Namely, the charging time of each pixel unit 101 is enhanced to twice.

Therefore, in the present disclosure, the charging time can be enhanced on conditional of the charging frequency are not enhanced during one frame of image being scanned .

Obviously, in another embodiment, the predetermined time can be a quarter of the scanning time, therefore, the gate driver 30 scans the next row of pixel units 101 after each row of pixel units has been scanned for three quarters of the scanning time. Thus also enhancing the charing time to some extent.

The display device 100 can be a liquid crystal display (LCD) television, a LCD display, a mobile phone, a tablet computer, a portable computer, and the like.

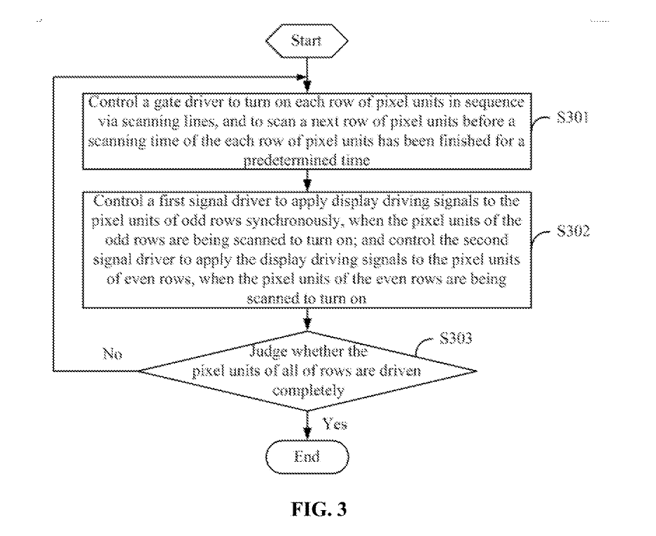

Referring to FIG. 3, a flowchart of a display driving method of the present invention is illustrated. At first, the time schedule controller 20 controls the gate driver 30 to turn on each row of pixel units 101 in sequence via the scanning lines G1-Gn, and to scan a next row of pixel units 101 before a scanning time of each row of pixel units 101 has been finished for a predetermined time (S301).

The time schedule controller 20 then controls the first signal driver 40 to apply display driving signals to the pixel units 101 of odd rows synchronously, when the pixel units 101 of the odd rows are being scanned to turn on, and controls the second signal driver 50 to apply the display driving signals to the pixel units 101 of even rows, when the pixel units 101 of the even rows are being scanned to turn on (S302).

The time schedule controller 20 then judges whether the pixel units 101 of all of rows are driven completely (S303). If yes, the process is ended, else, the process returns to the step S301.

The present invention may be embodied in other forms without departing from the spirit or novel characteristics thereof. The embodiments disclosed in this application are to be considered in all respects as illustrative and not limitative. The scope of the invention is indicated by the appended claims rather than by the foregoing description; and all changes which come within the meaning and range of equivalency of the claims are intended to be embraced therein.

What is claimed is:

1. A display device, comprising an array substrate, a time schedule controller, a gate driver, a first signal driver, and a second signal driver, the array substrate comprising a plurality of pixel units arrayed in matrix array, a plurality of scanning lines, a plurality of odd signal lines, and a plurality of even signal lines; each scanning line connected to pixel units of one corresponding row, each odd signal line connected to odd row pixel units of one corresponding column, each even signal line connected to even row pixel units of one corresponding column; the gate driver connected to all of the scanning lines, the first signal driver connected to all of the odd signal lines, the second signal driver connected to all of the even signal lines;
wherein, the time schedule controller controls the gate driver to turn on each row of pixel units in sequence via the scanning lines, and to scan a next row of pixel units before a scanning time of each row of pixel units has been finished for a predetermined time; the time schedule controller controls the first signal driver to apply the display driving signals to the pixel units of odd rows synchronously, when the pixel units of the odd rows are being scanned to turn on; the time schedule controller further controls the second signal driver to apply the display driving signals to the pixel units of even rows, when the pixel units of the even rows are being scanned to turn on.

2. The display device of claim 1, wherein the predetermined time is one half of the scanning time, the gate driver scans a next row of pixel units after each row of pixel units has been scanned for one half of the scanning time.

3. The display device of claim 1, wherein the predetermined time is a quarter of the scanning time, the gate driver scans a next row of pixel units after each row of pixel units has been scanned for three quarters of the scanning time.

4. The display device of claim 1, wherein the display device is a liquid crystal display (LCD) television, a LCD display, a mobile phone, a tablet computer, or a portable computer.

5. An display driving method, applied in a display device as claimed in claim 1, comprising:
a) controlling a gate driver to turn on pixel units of each row in sequence via scanning lines, and to scan pixel units of a next row before a scanning time of the pixel units of each row has been finished for a predetermined time; and
b) controlling a first signal driver to apply display driving signals to the pixel units of odd rows synchronously, when the pixel units of the odd rows are being scanned to turn on; and controlling the second signal driver to apply the display driving signals to the pixel units of even rows, when the pixel units of the even rows are being scanned to turn on.

6. The method of claim 5, further comprising:
judging whether the pixel units of all of rows are driven completely, if not, returning to the step a).

7. The method of claim 5, wherein the step a) comprises:
controlling the gate driver to turn on the each row of pixel units in sequence via scanning lines, and controlling the gate driver to scan a next row of pixel units after each row of pixel units has been scanned for one half of a scanning time.

8. The method of claim 5, wherein the step a) comprises:
controlling the gate driver to turn on the each row of pixel units in sequence via scanning lines, and controlling the gate driver to scan a next row of pixel units after each row of pixel units has been scanned for three quarters of a scanning time.
